(19) United States
(12) Patent Application Publication
(10) Pub. No.: US 2009/0164376 A1
(43) Pub. Date: Jun. 25, 2009

(54) Systems and Methods for Controlled Substance Prescription Monitoring Via Real Time Claims Network

(75) Inventor: Stephen Guthrie, Kennesaw, GA (US)

Correspondence Address: SUTHERLAND ASBILL & BRENNAN LLP, 999 PEACHTREE STREET, N.E., ATLANTA, GA, 30309, US

(73) Assignee: MCKESSON FINANCIAL HOLDINGS LIMITED, Hamilton (BM)

(21) Appl. No.: 11/961,559

(22) Filed: Dec. 20, 2007

(51) Int. Cl. G06Q 50/00; H04L 9/00

(52) U.S. Cl. 705/50; 705/2

(57) ABSTRACT

Embodiments of the invention can provide systems and methods for controlled substance prescription monitoring via a real time claims network. In one embodiment, a method for facilitating real-time processing of claims associated with one or more controlled substances can be provided. The method can include receiving a plurality of claims from a claims transaction switch, wherein each of the claims relates to both at least one predefined provider and at least one monitored controlled substance. In addition, the method can include validating some or all of the plurality of claims. Furthermore, the method can include formatting and transmitting data from validated claims to a prescription monitoring program system.

### FIELD OF THE INVENTION

The invention generally relates to prescriptions, and more particularly, to systems and methods for controlled substance prescription monitoring via a real time claims network.

### BACKGROUND OF THE INVENTION

The cost for prescription drugs and other medicines can be a recurring and increasing expense for many consumers. Pharmaceutical companies and generic drug manufacturers or providers can offer consumers competing drug and medicine products at different, sometimes substantially different, prices. In many instances, consumers may be unaware of the availability of and relative prices between the variety of drug and medicine product choices, including alternative drugs such as generic drugs.

About half of United States state governments have implemented some form of prescription monitoring program (PMP) to monitor and manage the prescribing and dispensing of controlled substances. In addition, the United States federal government has allocated significant grant funding to support states in their PMP efforts. PMP is a term generally used to describe a program implemented by a governmental entity to monitor the dispensing of controlled substances or drugs.

Many states maintain reporting and inquiry systems that permit authorized users to retrieve or analyze information about controlled substance dispensing activities, such as a listing of the scheduled (controlled substance) prescriptions a specified patient has had dispensed for a specified time period, as well as the associated prescriber and dispenser. Users of such systems can include prescribers of medical treatment for an existing or prospective patient, pharmacists for pharmaceutical treatment, law enforcement officers pursuing active investigations, and licensure boards for a licensee. Such systems enhance law enforcement and abuse intervention efforts, but also empower physicians and other healthcare providers to make better informed decisions that can greatly improve quality of patient care (for example, by reducing the risk of inadvertent overmedication or interactions, physicians feel more confident in prescribing adequate pain management regimens).

One problem is that conventional data collection processes that supply data used by such reporting systems may not provide that data in a timely, comprehensive, or clean fashion. As a result, the usefulness of conventional PMP reporting systems may be drastically reduced.

The diversion of prescription drugs for illegal use has been a problem for at least 40 years. However, over the last ten years, the number of controlled substance prescriptions in the United States has increased at a rate approximately ten times as fast as the population growth in the United States. The abuse of legal prescription drugs and their diversion into the illegal market have grown into pervasive public health and crime management problems. However, conventional systems that collect data to monitor such activity have progressed only marginally over approximately the same period.

Conventional data collection processes may gather data primarily through the submission of electronic batch files (and/or paper forms) to a central data aggregation system that then validates the content, aggregates the data, and forwards it to appropriate state systems. Because the submission process adds to pharmacy workload, it is too burdensome for pharmacies to submit data daily. Various states therefore may require data submission at best weekly, and commonly, as infrequently as every two weeks or monthly. Aggregators then must process and validate the received files, adding additional delays. These conventional processes typically result in data not being delivered to state systems until several days, in some instances between about 13 to 21 days, or more after dispensing occurs. This time lag greatly reduces the value of collected data, especially in its ability to support prevention and intervention efforts.

Therefore, a need exists for systems and methods for controlled substance prescription monitoring via a real time claims network.

Moreover, a need exists for systems and methods for monitoring and processing controlled substance prescriptions via a real time claims network.

In addition, a need exists for systems and methods for monitoring and processing transactions associated with controlled substance prescriptions via a real time claims network.

### SUMMARY OF THE INVENTION

Embodiments of the invention can provide some or all of the above needs. Embodiments of the invention can provide controlled substance prescription monitoring via a real time claims network. Moreover, embodiments of the invention can provide monitoring and processing controlled substance prescriptions via a real time claims network. In addition, embodiments of the invention can provide monitoring and processing transactions associated with controlled substance prescriptions via a real time claims network. In one embodiment, a claims handling switch or claims switch can provide or otherwise receive real time, or near real time, transaction information from one or more dispensers and third party plans for processing to determine selected transactions and associated data for reporting to a prescription monitoring program associated with a governmental entity.

In accordance with another embodiment of the invention, a controlled substance claims handling system for facilitating real-time processing of claims can be provided. The claims handling system can include a prescription monitoring application operable to receive a plurality of claims associated with one or more controlled substances, wherein each of the claims relates to both at least one predefined provider and at least one monitored controlled substance. The prescription monitoring application is further operable to validate at least a portion of the plurality of claims. In addition, the prescription monitoring application is operable to transmit data associated with validated claims to a prescription monitoring program system.

In another embodiment, a method for facilitating real-time processing of claims associated with one or more controlled substances can be provided. The method can include receiving a plurality of claims from a claims transaction switch, wherein each of the claims relates to both at least one predefined provider and at least one monitored controlled substance. In addition, the method can include validating some or all of the plurality of claims. Furthermore, the method can include formatting and transmitting data from validated claims to a prescription monitoring program system.

In yet another embodiment, a system for facilitating real-time or near real-time processing of controlled substance claims can be provided. The system can include a prescription monitoring application operable to receive a plurality of claims associated with one or more controlled substances, wherein each of the claims relates to both at least one predefined provider and at least one monitored controlled substance. In addition, the prescription monitoring application can be operable to filter at least a portion of the plurality of claims to exclude any reversal transactions and any multiple claims for similar prescription requests. Furthermore, the prescription monitoring application can be operable to format at least a portion of data from any validated claims in a predefined format, such as an American Society for Automation in Pharmacy (ASAP)-type reporting format, prior to transmission. The prescription monitoring application can be further operable to encrypt at least a portion of data from any validated claim prior to transmission. Moreover, the prescription monitoring application can be operable to transmit data from the validated claims to a prescription monitoring program system.

In an additional embodiment, a method for facilitating real-time or near real-time processing of controlled substance prescription claims can be provided. The method can include receiving a plurality of claims from a claims transaction switch, wherein each of the claims relates to both at least one predefined provider and at least one monitored controlled substance. The method can also include filtering some or all of the plurality of claims to exclude any reversal transactions and any multiple claims for similar prescription requests. Furthermore, the method can include formatting data from at least a portion of data from any validated claim in a predefined format, such as an American Society for Automation in Pharmacy (ASAP)-type format, prior to transmission. In addition, the method can include encrypting at least a portion of data from any validated claim prior to transmission. Moreover, the method can include transmitting the validated claims to a prescription monitoring program system.

Other systems and processes according to various embodiments of the invention will become apparent with respect to the remainder of this document.

### BRIEF DESCRIPTION OF THE DRAWINGS

Reference will now be made to the accompanying drawings, which are not necessarily drawn to scale, and wherein:

FIG. 1 illustrates a schematic view of an example data flow in accordance with an embodiment of the invention.

FIG. 2 illustrates an example system in accordance with an embodiment of the invention.

FIGS. 3-4 are process flowcharts illustrating example methods in accordance with embodiments of the invention.

### DETAILED DESCRIPTION OF EMBODIMENTS OF THE INVENTION

The invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will convey the scope of the invention. Like numbers refer to like elements throughout.

As used herein, the terms “controlled drug”, “controlled substance”, “controlled substance prescription”, “controlled prescription”, “controlled prescription drug”, and their respective pluralized forms are used interchangeably throughout the description, and should be construed to cover any federal, state, or locally-controlled drug, medication, or chemical composition, including but not limited to, Schedule II list-type drugs, Schedule III list-type drugs, Schedule IV list-type drugs, Schedule V list-type drugs, federally regulated drugs, state regulated drugs, and any substance or drug subject to any requirement or obligation to submit data or otherwise report the use of the substance or drug for use in an entity's prescription monitoring program (PMP).

The terms “dispenser” and “provider”, and their respective pluralized forms are used interchangeably throughout the description, and should be construed to cover any dispenser or provider of a controlled drug or substance.

The terms “transaction”, “claims transaction”, “claim transaction”, “claim”, and their respective pluralized forms are used interchangeably throughout the description, and should be construed to cover any form of data associated with a drug purchase on behalf of a customer or patient.

The term “predefined format” describes any data reporting format which is specified, described, mandated, required, or otherwise designated by an entity, state, government, governmental agency, authority, organization, or prescription monitoring program.

The term “computer-readable medium” describes any form of memory or a propagated signal transmission medium. Propagated signals representing data and computer-executable instructions can be transferred between network devices and systems.

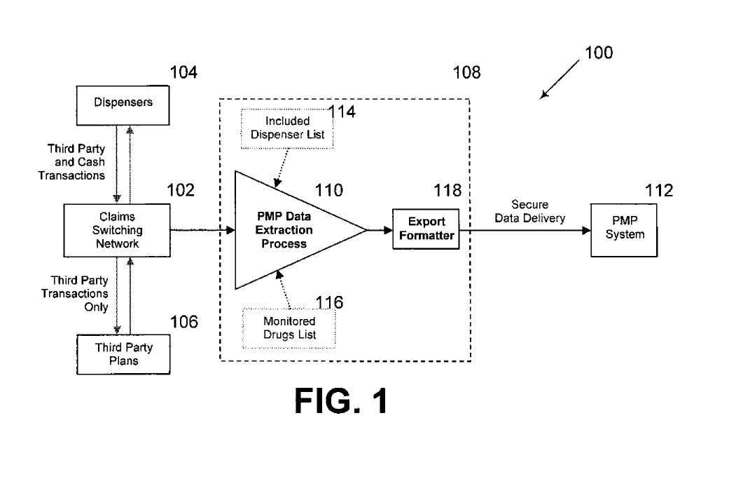

In FIG. 1, an example schematic of a data flow 100 for a controlled substance claim handling system is shown. The data flow 100 is shown by way of example, and in other embodiments, similar or different data flow components, data flow inputs, and data flow outputs may exist. In the example shown in FIG. 1, the data flow 100 can be initially handled by a claims switching network 102. Data handled or otherwise received by the claims switching network 102 can include any number of and different types of transactions such as prescription drug claims transactions. At least two types of claims transactions, “cash fill” and “third party fill” transactions, can be handled by the claims switching network 102. A “cash fill” transaction is when a patient pays the entire drug prescription price in cash. A “third party fill” transaction is when a third party, such as an insurance company, pays some or all of the drug prescription price. In any instance, the claims switching network 102 can interact with one or more dispensers 104 and/or one or more third party plans 106 as needed in order to adjudicate claims transactions received by the network 102. A dispenser 104 can be any entity that can provide a prescription drug, such as a controlled substance prescription drug, such as a pharmacy, hospital, drug store, online drug store, drug vendor, self dispensing clinic, or other supplier of drugs. A third party plan 106 can be an entity that administers an insurance or benefits plan, such as an insurance company, health benefits administrator, HMO, PPO, or third party plan administrator.

Some or all of the dispensers 104 can transmit one or more transactions, such as “cash fill” and “third party fill” transactions, to the claims switching network 102. Likewise, some or all of the third party plans 106 can transmit one or more transactions, such as “third party fill” transactions, to the claims switching network 102. Transactions received by the claims switching network 102 can also include “cash fill” claims submitted by one or more dispensers 104 via a “pseudo” third party plan. Furthermore, transactions received by the claims switching network 102 can also include copies of claims or transactions submitted via other claim networks by dispensers 104 who may use other claim network vendors. In one embodiment, a claims switching network 102 can implement one or more pre-editing and/or post-editing (PPE) services on some or all of the transactions prior to subsequent transmission of the transactions. In other embodiments, a claims switching network 102 can provide other value-added services for dispensers and/or third party plans by using one or more methods, devices, or routines to intelligently act on transaction data based at least in part on the transaction content.

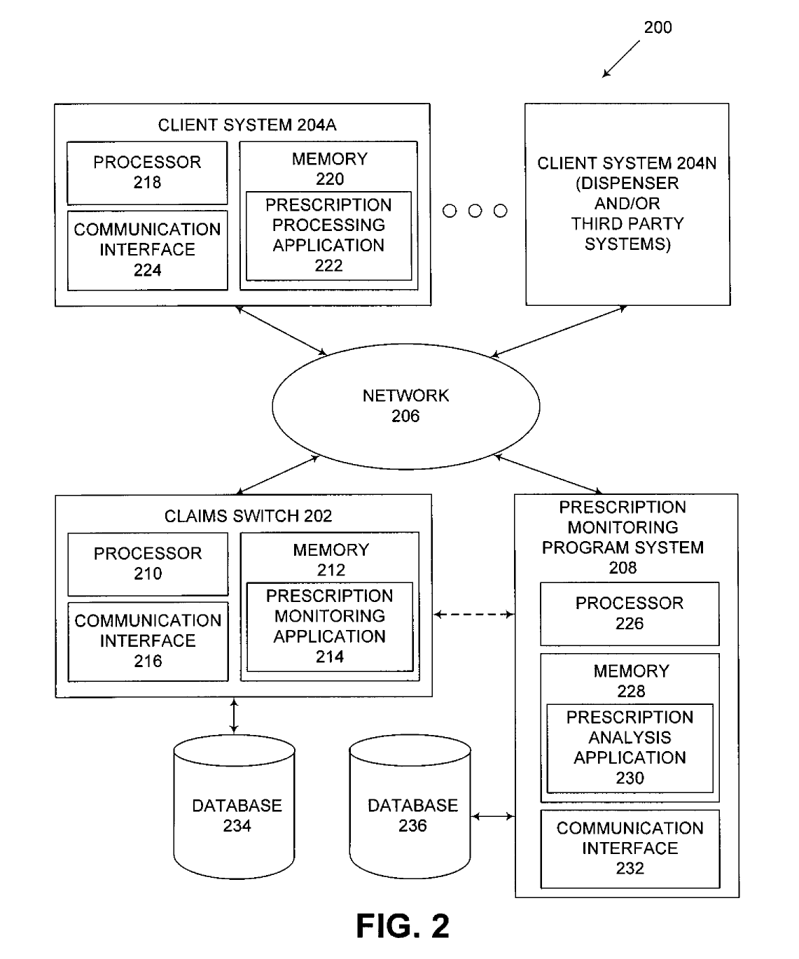

Rather than using conventional batch file submission procedures, the claims switching network 102 can transmit, in real time or near real time, some or all of the transactions to a claims handling system 108 via at least one network, similar to 206 shown in FIG. 2. The claims handling system 108 shown in FIG. 1 can include a claims handling process, such as a PMP data extraction process 110. Any number of transactions from the claims switching network 102 can be received by the PMP data extraction process 110 for processing.

A claims handling process, such as a PMP data extraction process 110, can process some or all of the transactions received from the claims switching network 102, and transmit a selected portion of the received transactions to a prescription monitoring program system, such as 112 described in further detail below. In the embodiment shown in FIG. 1, the PMP data extraction process 110 can utilize one or more processes, filters, lists, screens, devices or other routines to select a portion of the received transactions to transmit to a prescription monitoring program system. In other words, one or more processes, filters, lists, screens, devices or other routines can be used to exclude certain data or transactions prior to transmitting data or transactions to a prescription monitoring program system. Data or transactions that are processed, filtered, screened, or otherwise reviewed prior to transmission to a prescription monitoring program system, such as 112, can also be referred to as “validated” data or transactions. For example, as shown in FIG. 1, an included dispenser list 114 can be accessed by or otherwise implemented by the PMP data extraction process 110. An included dispenser list can include one or more dispensers that have been pre-approved or otherwise agree to participate in a prescription monitoring program, or that have been otherwise included in the list. The PMP data extraction process 110 can utilize the included dispenser list 114 to filter, screen, or otherwise identify or select specific data, such as transactions associated with pre-approved or participating dispensers, from some or all of the transactions received from the claims switching network 102. In this manner, transactions or other certain data associated with at least one dispenser on the included dispenser list 114 can be transmitted to a prescription monitoring program system, such as 112.

In another example, a monitored drugs list 116 can be accessed by or otherwise implemented by the PMP data extraction process 110. A monitored drugs list can include any number of national drug code (NDC) numbers which correspond to particular prescription drugs or controlled substances that have been previously selected for inclusion on the list. The PMP data extraction process 110 can utilize the monitored drugs list 116 to filter, screen, or otherwise select specific data, such as transactions associated with corresponding prescription drugs or controlled substances, from some or all of the transactions received from the claims switching network 102. In this manner, transactions or other certain data associated with at least one prescription drugs or controlled substances on the monitored drugs list 116 can be transmitted to a prescription monitoring program system, such as 112. Thus, a “monitored controlled substance” or drug is a controlled substance or drug that is referenced in a monitored drugs list.

In another example, any number of rules provided by a governmental entity, such as a federal, state, or local agency, organization, authority, or prescription monitoring program can be accessed by or otherwise implemented by the PMP data extraction process 110. Since each state, such as Kentucky and Georgia, may regulate different dispensers and controlled substances or drugs, each state may have a different list of dispensers and controlled substances or drugs to monitor and screen transactions with. In this example, a list from Kentucky may include drug enforcement agency (DEA) numbers or National Provider ID (NPI) numbers associated with certain pre-approved dispensers. Another list may include a unique number, such as a NDC number, which indicates a certain product, manufacturer, and packaging type for a particular controlled substance or drug. The PMP data extraction process 110 can utilize some or all of the rules to filter, screen, or otherwise select specific data, such as transactions that meet any predefined criteria specified by at least one rule, from some or all of the transactions received from the claims switching network 102. By way of further example, each state may have different rules for validating transactions. The PMP data extraction process 110 can implement different rules for different states, and can provide lists of or otherwise report some or all of the validated and non-validated transactions as well as associated data to the respective prescription monitoring program system, such as 112. In any instance, transactions or other certain data associated with any predefined criteria specified by at least one rule can be transmitted to a prescription monitoring program system, such as 112.

In one embodiment, another suitable filter can be a filter that can exclude one or more transactions with corresponding reversal transactions in the same day or a predefined time period. This filter can exclude certain transactions since a pair or series of corresponding transactions may not indicate actual dispensing of a drug if a net payment is not made or otherwise does not occur. Collectively, a set of these types of transactions can be referred to as a “reversal”. Thus, in this example, the PMP data extraction process 110 can utilize this particular filter to filter, screen, or otherwise identify or select specific data for exclusion, such as transactions with corresponding reversal transactions in the same day or a predefined time period, from some or all of the transactions received from the claims switching network 102. In this manner, transactions or other certain data associated with corresponding reversal transactions in the same day or a predefined time period can be excluded from transmission to a prescription monitoring program system, such as 112. Collectively, a set of these types of transactions can be referred to as a “rebill”.

In one embodiment, another suitable filter can be a filter that reconciles multiple claims in the same day or predefined period for the same patient prescription fill, also known as “coordination of benefits”. That is, multiple claims on the same day or predefined time period by the same patient for the same prescription drug can be reconciled as a single prescription dispensing event. In this manner, multiple transactions can be reconciled as a single transaction for a patient with multiple insurance plans that each pay a portion of the price for a single prescription fill. Thus, in this example, the PMP data extraction process 110 can utilize this particular filter to filter, screen, or otherwise identify or select specific data for exclusion, such as transactions associated with multiple claims in the same day or predefined time period for the same patient prescription fill or other transactions associated with a “coordination of benefits”, from some or all of the transactions received from the claims switching network 102. In this manner, transactions or other certain data associated with multiple claims in the same day or predefined time period for the same patient prescription fill, also known as “coordination of benefits”, can be reconciled as a single claim transaction prior to transmission to a prescription monitoring program system, such as 112.

Prior to transmitting selected transaction data to a prescription monitoring program system 112, the PMP data extraction process 110 can utilize a formatter such as an export formatter 118 to format or otherwise process some or all of the selected transaction data. In the embodiment shown in FIG. 1, the export formatter 118 can map or otherwise organize selected data in a suitable predefined format, such as a reporting format suitable for export to or receipt by the prescription monitoring program system 112. In one embodiment, a suitable predefined format can be a prescription monitoring program (PMP) format, such as an American Society for Automation in Pharmacy (ASAP)-type format, for instance, ASAP95. In other embodiments, various other predefined formats, including other PMP submission formats, such as an ASAP-type format, formats otherwise administered by or published by the American Society for Automation in Pharmacy or other standards organizations, or other similar formats can be implemented by the export formatter 118. In some instances, each governmental entity associated with a prescription monitoring program system, such as 112, may require different predefined formats. For these instances, an export formatter 118 can select a suitable predefined format to organize and transmit data to the prescription monitoring program system, such as 112, or to multiple prescription monitoring program systems, similar to 112.

Transaction data formatted for the prescription monitoring program system 112 can be transmitted by the claims handling system 108 via at least one network, shown as 206 in FIG. 2, to the prescription monitoring program system 112. In one embodiment, a suitable data security device or process can be applied to the formatted transaction data to provide relatively secure data transmission from the claims handling system 108 to the prescription monitoring program system 112. In another embodiment, a data security can be maintained by transmitting the formatted transaction data via a dedicated wireless frequency in a network, such as 206, from the claims handling system 108 to the prescription monitoring program system 112.

Typically, the transmission of transaction data from the PMP data extraction process 110 is performed in real time or near real time. In at least one embodiment, transaction data can be transmitted by the PMP data extraction process 110 to the prescription monitoring program system 112 at a predefined frequency, for example, every hour, every 6 hours, every 12 hours, or every 24 hours.

A prescription monitoring program system, such as 112, can include a system, computer, or an application program associated with an entity that monitors the dispensing of controlled substances, such as a federal, state, or local governmental agency or entity. In one embodiment, a prescription monitoring program system can be a computer system that collects or otherwise receives transaction data in at least one reporting format published by the ASAP. Although a single prescription monitoring program system 112 is shown in FIG. 1, in other embodiments, there may be multiple single prescription monitoring program systems similar to 112 and in communication with the claims handling system 108 and PMP data extraction process 110, wherein each prescription monitoring program system can be associated with a respective state or entity.

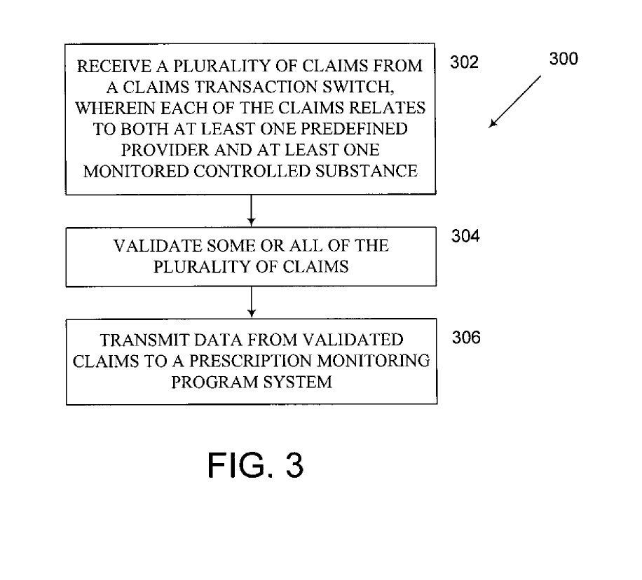

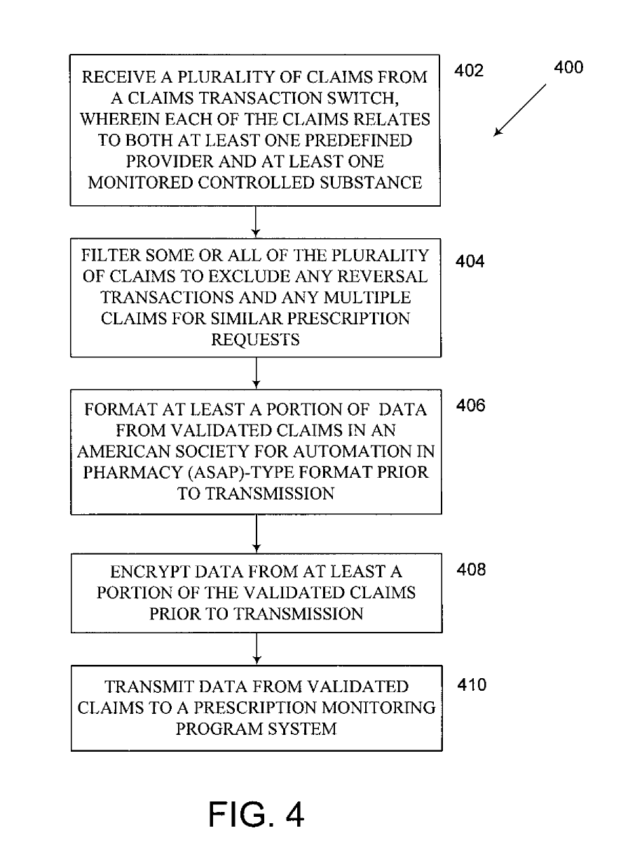

Embodiments of a data flow, such as 100, for a system can facilitate real time monitoring and processing of controlled substance prescription claims. Furthermore, embodiments of a data flow, such as 100, for a system can facilitate real time monitoring and processing controlled substance prescriptions. In addition, embodiments of a data flow, such as 100, for a system can facilitate real time monitoring and processing transactions associated with controlled substance prescriptions. Example operation of a data flow, such as 100 of FIG. 1, for a system and its various components as well as associated methods and processes are described by reference to FIGS. 3 and 4.

FIG. 2 illustrates an example system in accordance with an embodiment of the invention. In this example, a claims handling system 200 can include a claims switch 202 in communication with one or more client systems 204A-204N via at least one network 206, or via one or more separate networks. In addition, the claims handling system 200 can also be in communication with a prescription monitoring program system 208 via the at least one network 206, or via one or more separate networks. In the example shown in FIG. 2, the claims handling system 200 can monitor and process one or more transactions, such as prescription drug claims transactions, via a real time claims network. The claims handling system 200 and associated components are shown by way of example, and in other embodiments, similar or different components, data inputs, and data outputs may exist. For instance, the claims handling system, shown as 108 in FIG. 1, is another embodiment of the invention and can perform some or all of the functionality described with respect to the claims handling system 200 in FIG. 2.

The claims switch 202 can be a switch operable to handle and process one or more claims transactions, such as prescription transactions and controlled substance prescription transactions. With reference to FIG. 1, some or all of the functionality described with respect to the claims switching network 102 and claims handling system 108 can be performed or otherwise implemented by the claims switch 202. In one embodiment, a claims switch 202 can be a server, multiple servers, or any number of processor-based devices. The claims switch 202 is further operable to receive one or more claims transactions from any number of client systems 204A-204N. At least two types of claims transactions, such as “cash fill” and “third party fill” transactions described above, can be handled by the claims switch 202. Transactions received by the claims switch 202 can also include claims submitted by one or more client systems, such as 204A-204N, via a “pseudo” third party plan or cash fills. Transactions received by the claims switch 202 can also include copies of claims or transactions submitted via other claim networks by dispensers 104 who may use other claim network vendors. As shown in FIG. 2, a claims switch 202 can include a processor 210, a memory 212 with a prescription monitoring application 214, and a communication interface 216. The processor 210 can be operable to execute the prescription monitoring application 214 or other set of computer-executable instructions stored in the memory 212. In other embodiments, the processor 210 can be operable to access and read various associated computer-readable media having stored thereon data and/or computer-executable instructions for implementing methods according to embodiments of the invention. The communication interface 216 can be operable to receive input from a user, generate an output for the user, and communicate with one or more client systems 204A-204N and the prescription monitoring system 208. In some embodiments, a claims switch 202 can include various input/output (I/O) devices, such as a keyboard, mouse, printer, microphone, speaker, monitor, bar code readers/scanners, RFID readers, and the like. Furthermore, in some embodiments, a communication interface 216 may take any number of forms, such as a network interface card, a modem, a wireless network card, and the like.

A prescription monitoring application 214 can implement or otherwise utilize any number of processes, filters, lists, screens, devices or other routines to select a portion of the received claims transactions to transmit to a prescription monitoring program system, such as 208. In addition, such processes, filters, lists, screens, devices or other routines can be used to exclude certain data or transactions prior to transmitting data or transactions to a prescription monitoring program system, such as 208. Data or transactions that are processed, filtered, screened, or otherwise reviewed prior to transmission to a prescription monitoring program system, such as 208, can also be referred to as “validated” data or transactions. Examples of processes, filters, lists, screens, devices or other routines can include, but are not limited to, a dispenser list such as 114; a monitored drugs list such as 116; any number of rules provided by a governmental entity such as a federal, state, or local agency; a filter to screen or reconcile transactions associated with multiple claims in the same day or predefined time period for the same patient prescription fill; a filter to screen or reconcile transactions associated with a “coordination of benefits”; and a filter to screen or reconcile transactions with corresponding reversal transactions in the same day or a predefined time period.

In one embodiment, each state may have different rules for validating transactions. The prescription monitoring application 214 can implement different rules for different states, and can provide lists of or otherwise report some or all of the validated and non-validated transactions as well as associated data to the respective prescription monitoring program system, such as 208.

Prior to transmitting the selected or validated data or transactions, the claims transactions, the prescription monitoring application 214 can format some or all of the data or transactions. In one embodiment, the prescription monitoring application 214 can format the data or transactions in a predefined format such as a prescription monitoring program format, including but not limited to, an American Society for Automation in Pharmacy (ASAP)-type format, for instance, ASAP95. In any instance, the prescription monitoring application 214 is operable to provide or otherwise facilitate formatting similar to the predefined formats and functionality described above with respect to the export formatter 118 in FIG. 1. In some instances, each governmental entity associated with a prescription monitoring program system, such as 208, may require different predefined formats. For these instances, the prescription monitoring application 214 can select a suitable predefined format to organize and transmit data to the prescription monitoring program system, such as 208.

Typically, the transmission of transaction data from the prescription monitoring application 214 to the prescription monitoring program system 208 is performed in real time or near real time. In at least one embodiment, transaction data can be transmitted by the prescription monitoring application 214 to the prescription monitoring program system 208 at a predefined frequency, for example, every hour, every 6 hours, every 12 hours, or every 24 hours.

In one embodiment, a prescription monitoring application, such as 214, can be operable to receive a plurality of claims associated with one or more controlled substances, wherein each of the claims relates to both at least one predefined provider and at least one monitored controlled substance. Further, the prescription monitoring application can be operable to validate at least a portion of the plurality of claims. In addition, the prescription monitoring application can be operable to transmit data associated with validated claims to a prescription monitoring program system. In another embodiment, a prescription monitoring application can be operable to format data from at least a portion of the validated claims in a predefined format prior to transmission.

In another embodiment, a prescription monitoring application, such as 214, can be operable to receive a plurality of claims from a claims transaction switch, wherein each of the claims relates to both at least one predefined provider and at least one monitored controlled substance. In addition, the prescription monitoring application can be operable to filter some or all of the plurality of claims to exclude any reversal transactions and any multiple claims for similar prescription requests. Furthermore, the prescription monitoring application can be operable to format data from at least a portion of data from any validated claim in a predefined format prior to transmission. The prescription monitoring application can be further operable to encrypt at least a portion of data from any validated claims prior to transmission. Moreover, the prescription monitoring application can be operable to transmit the data from any validated claims to a prescription monitoring program system.

Although a single prescription monitoring application 214 is shown in FIG. 2, other embodiments may have multiple prescription monitoring applications similar to 214. Such embodiments can include hosting other prescription monitoring applications similar to 214 in various system components including, but not limited to, a claims switch 202, one or more client systems 204A-204N, components associated with the network 206, or a prescription monitoring program system 208.

The claims switch 202 shown in FIG. 2 may include additional instructions or access other program modules for performing other pre-processing or post-processing methods described herein. One may appreciate that the claims switch 202 may include alternate and/or additional components, hardware or software.

The network 206 can be any telecommunication and/or data network, whether public, private, or a combination thereof, including a local area network, a wide area network, an intranet, an internet, the Internet, intermediate hand-held data transfer devices, and/or any combination thereof and may be wired and/or wireless. The network 206 may also allow for any combination of real-time, near real-time, off-line, and/or batch transactions to be transmitted between the claims switch 202, client systems 204A-204N, and prescription monitoring program system 208. Due to network connectivity, various methodologies as described herein may be practiced in the context of distributed computing environments. Although the client systems 204A-204N are shown for simplicity as being in communication with the claims switch 202 via one intervening network 206, it is to be understood that any other network configuration is possible. For example, intervening network 206 may include a plurality of networks, each with devices such as gateways and routers for providing connectivity between or among any number of networks. Instead of or in addition to a network 206, dedicated communication links may be used to connect the various components or devices of embodiments of the invention. In one example, a dedicated communication link can be used to facilitate relatively secure data transmission between the claims switch 202 and the prescription monitoring program system 208.

Each of the client systems, such as 204A-204N, can be administered by a respective dispenser or a third party plan, as described above. In one embodiment, each of the client systems 204A-204N can be any processor-driven device, such as a personal computer, laptop computer, handheld computer, or mainframe computer. As shown in FIG. 2, a client system, such as 204A can include a processor 218, a memory 220 with a prescription processing application 222, and a communication interface 224. The processor 218 can be operable to execute the prescription processing application 222 or other set of computer-executable instructions stored in the memory 220. In other embodiments, the processor 218 can be operable to access and read various associated computer-readable media having stored thereon data and/or computer-executable instructions for implementing methods according to embodiments of the invention. The communication interface 224 can be operable to receive input from a user, generate an output for the user, and communicate with the claims switch 202 and the prescription monitoring system 208 as needed. For example, the prescription processing application 222 may include or otherwise facilitate access to the network 206 by way of an Internet browser or other software, including a dedicated program, for interacting with the claims switch 202. In one embodiment, a user, such as a pharmacist, or other pharmacy employee, may utilize the prescription processing application 222 in preparing and providing a prescription drug request or order to the claims switch 202 for processing. The prescription processing application 222 can be utilized to retrieve or otherwise receive data from the claims switch 202, including pricing and discount information for the prescription drug request or order, and pricing and discount information for any controlled substances or drugs. In some embodiments, client systems 204A-204N can include various input/output (I/O) devices, such as a keyboard, mouse, printer, microphone, speaker, monitor, bar code readers/scanners, RFID readers, and the like. Furthermore, in some embodiments, a communication interface 224 may take any number of forms, such as a network interface card, a modem, a wireless network card, and the like. The client systems 204A-204N may include additional instructions or access other program modules for performing other pre-processing or post-processing methods described herein. One may appreciate that the client systems 204A-204N may include alternate and/or additional components, hardware or software.

The prescription monitoring program system 208 can be administered by an entity that monitors the dispensing of controlled substances, such as a federal, state, or local governmental agency or entity. As shown in FIG. 2, a prescription monitoring program system 208 can include a processor 226, a memory 228 with a prescription analysis application 230, and a communication interface 232. The processor 226 can be operable to execute the prescription analysis application 230 or other set of computer-executable instructions stored in the memory 228. In the embodiment shown, the prescription analysis application 230 can receive selected data from claims transactions from the claims switch 202. In one embodiment, the prescription analysis application 226 can perform some or all of the functionality described with respect to the prescription monitoring application 214 associated with the claims switch 202. In other embodiments, the processor 230 can be operable to access and read various associated computer-readable media having stored thereon data and/or computer-executable instructions for implementing methods according to embodiments of the invention. The communication interface 232 can be operable to receive input from a user, generate an output for the user, and communicate with the claims switch 202 and the any number of the client systems 204A-204N as needed. In some embodiments, a prescription monitoring program system 208 can include various input/output (I/O) devices, such as a keyboard, mouse, printer, microphone, speaker, monitor, bar code readers/scanners, RFID readers, and the like. Furthermore, in some embodiments, a communication interface 232 may take any number of forms, such as a network interface card, a modem, a wireless network card, and the like. The prescription monitoring program system 208 may include additional instructions or access other program modules for performing other pre-processing or post-processing methods described herein. One may appreciate that the prescription monitoring program system 208 may include alternate and/or additional components, hardware or software.

Although a single prescription monitoring program system 208 is shown in FIG. 2, in other embodiments, there may be multiple single prescription monitoring program systems similar to 208 and in communication with the claims switch 202 and prescription monitoring application 214.

As illustrated in FIG. 2, the claims switch 202 may include or be in communication with at least one data storage device, such as database 234. If the claims switch 202 includes a data storage device, then the data storage device could also be part of the memory 212. The data storage device or database 234 and/or memory 212 may store, for example, previously received transactions and associated data, selected or excluded transactions and associated data, and any number of business rules, filters, or screens for processing transactions. Although a single data storage device or database 234 is referred to herein for simplicity, one will appreciate that multiple physical and/or logical data storage devices or databases may be used to store the above mentioned data. For security and performance purposes, the claims switch 202 may have a dedicated connection to the data storage device or database 234, as shown. However, the claims switch 202 may also communicate with the data storage device or database 234 via a network 206. In other embodiments of the invention, the claims switch 202 may include the data storage device or database 234 locally. The claims switch 202 may also otherwise be part of a distributed or redundant database management system (DBMS).

Similar to the claims switch 202, the prescription monitoring program system 208 may include or be in communication with at least one data storage device or database 236, similar to 234.

One will appreciate that components of the system 200 shown in and described with respect to FIG. 2 are provided by way of example only. Numerous other operating environments, system architectures, and device configurations are possible. Accordingly, embodiments of the invention should not be construed as being limited to any particular operating environment, system architecture, or device configuration.

Embodiments of a system, such as 200, can facilitate real time monitoring and processing of controlled substance prescription claims. Furthermore, embodiments of a system, such as 200, can facilitate real time monitoring and processing of controlled substance prescriptions. In addition, embodiments of a system, such as 200, can facilitate real time monitoring and processing transactions associated with controlled substance prescriptions. Example operation of a system, such as 200 of FIG. 2, and its various components as well as associated methods and processes are described by reference to FIGS. 3 and 4.

FIGS. 3 and 4 are process flowcharts illustrating example methods in accordance with embodiments of the invention. The example method 300 shown in FIG. 3 provides a method for facilitating real-time processing of claims associated with one or more controlled substances. The method 300 can be implemented by various components shown in FIG. 1, or a system, such as 200 of FIG. 2.

The method 300 begins at block 302. In block 302, a plurality of claims is received from a claims transaction switch, wherein each of the claims relates to both at least one predefined provider and at least one monitored controlled substance. For example, as shown in FIG. 1, one or more prescription drug claims or transactions associated with a consumer and originating at a dispenser 104 or third party plan 106 can be received by a claims switching network 102. In this example, one or more prescription drug claims or transactions associated with a consumer and originating at a dispenser 104 or third party plan 106 can be received by a claims switching network 102. The claims switching network 102 can transmit some or all of the prescription drug claims or transactions to a claims handling system 108 for further processing. In another example, one or more prescription drug claims or transactions associated with a consumer and originating at a client system 204A-204N associated with a dispenser or third party plan can be received by a claims switch 202.

Block 302 is followed by block 304, in which some or all of the plurality of claims are validated. For example, as shown in FIG. 1, a PMP data extraction process 110 can implement one or more processes, filters, screens, devices, or other routines to validate some or all of the prescription drug claims or transactions received from the claims switching network 102. In this example, a dispenser list 114 and a monitored drugs list 116 can be implemented by the PMP data extraction process 110 to select or otherwise validate certain prescription drug claims or transactions. In any instance, the PMP data extraction process 110 can determine one or more selected or otherwise validated prescription drug claims or transactions to transmit to the prescription monitoring program system 112. In another example, as shown in FIG. 2, a processor 210 or prescription monitoring application 214 can implement one or more processes, filters, screens, devices, or other routines to validate some or all of the prescription drug claims or transactions received from one or more claims systems 204A-204N. In this example, a dispenser list such as 114 and a monitored drugs list such as 116 can be implemented by the processor 210 or prescription monitoring application 214 to select or otherwise validate certain prescription drug claims or transactions. In any instance, the processor 210 or prescription monitoring application 214 can determine one or more selected or otherwise validated prescription drug claims or transactions to transmit to the prescription monitoring program system 208.

Block 304 is followed by block 306, wherein data from validated claims are formatted and transmitted to a prescription monitoring program system. For example, as shown in FIG. 1, the PMP data extraction process 110 can implement an export formatter 118 to format data from any selected or validated prescription drug claims or transactions. As discussed above, the export formatter 118 can format data from some or all of the claims or transactions in a predefined format, such as an ASAP-type format. The PMP data extraction process 110 can then transmit formatted data from the prescription drug claims or transactions to the prescription monitoring program system 112. In another example, as shown in FIG. 2, the processor 210 or prescription monitoring application 214 can format data from any selected or validated prescription drug claims or transactions prior to transmission. The processor 210 or prescription monitoring application 214 can format data from some or call of the claims or transactions in an ASAP-type format similar to the functionality provided by the export formatter 118 described in FIG. 1. The processor 210 or prescription monitoring application 214 can then transmit formatted data from prescription drug claims or transactions to the prescription monitoring program system 208.

The method 300 of FIG. 3 ends after block 306.

The example method 400 shown in FIG. 4 provides a method for facilitating real-time or near real-time processing of controlled substance prescription claims. The method 400 can be implemented by various components shown in FIG. 1, or a system, such as 200 of FIG. 2.

The method 400 begins at block 402. In block 402, a plurality of claims is received from a claims transaction switch, wherein each of the claims relates to both at least one predefined provider and at least one monitored controlled substance. For example, as shown in FIG. 1, one or more prescription drug claims or transactions associated with a consumer and originating at a dispenser 104 or third party plan 106 can be received by a claims switching network 102. In this example, one or more prescription drug claims or transactions associated with a consumer and originating at a dispenser 104 or third party plan 106 can be received by a claims switching network 102. The claims switching network 102 can transmit some or all of the prescription drug claims or transactions to a claims handling system 108 for further processing. In another example, one or more prescription drug claims or transactions associated with a consumer and originating at a client system 204A-204N associated with a dispenser or third party plan can be received by a claims switch 202.

Block 402 is followed by block 404, in which some or all of the plurality of claims are filtered to exclude any reversal transactions and any multiple claims for similar prescription requests. For example, as shown in FIG. 1, a PMP data extraction process 110 can implement one or more processes, filters, screens, devices, or other routines to filter some or all of the prescription drug claims or transactions received from the claims switching network 102. In this example, a filter to screen or reconcile transactions associated with multiple claims in the same day or predefined time period for the same patient prescription fill, and a filter to screen or reconcile transactions with corresponding reversal transactions in the same day or a predefined time period can be implemented by the PMP data extraction process 110 to select or otherwise validate certain prescription drug claims or transactions. In any instance, the PMP data extraction process 110 can determine one or prescription drug claims or transactions to filter and subsequently exclude from transmission to the prescription monitoring program system 112. In another example, as shown in FIG. 2, a processor 210 or prescription monitoring application 214 can implement one or more processes, filters, screens, devices, or other routines to filter some or all of the prescription drug claims or transactions received from one or more claims systems 204A-204N. In this example, a filter to screen or reconcile transactions associated with multiple claims in the same day or predefined time period for the same patient prescription fill, and a filter to screen or reconcile transactions with corresponding reversal transactions in the same day or a predefined time period can be implemented by the processor 210 or prescription monitoring application 214 to filter and subsequently exclude from transmission certain prescription drug claims or transactions. In any instance, the processor 210 or prescription monitoring application 214 can determine one or more prescription drug claims or transactions to filter and subsequently exclude from transmission to the prescription monitoring program system 208.

Block 404 is followed by block 406, in which data from at least a portion of any validated claim is formatted in a predefined format prior to transmission. For example, as shown in FIG. 1, the PMP data extraction process 110 can implement an export formatter 118 to format data from any selected or validated prescription drug claims or transactions. As discussed above, the export formatter 118 can format data from some or all of the claims or transactions in a predefined format, such as an ASAP-type format. In another example, as shown in FIG. 2, the processor 210 or prescription monitoring application 214 can format data from any selected or validated prescription drug claims or transactions prior to transmission. The processor 210 or prescription monitoring application 214 can format data from some or call of the claims or transactions in a predefined format, such as an ASAP-type format, similar to the functionality provided by the export formatter 118 described in FIG. 1.

Block 406 is followed by block 408, in which at least a portion of data from any validated claim is encrypted prior to transmission. For example, as shown in FIG. 1, the PMP data extraction process 110 can implement an encryption routine or device to transmit data from some or all of the selected or validated prescription drug claims or transactions to the prescription monitoring program system 112. In another example, as shown in FIG. 2, the processor 210 or prescription monitoring application 214 can encrypt data from any selected or validated prescription drug claims or transactions prior to transmission. The processor 210 or prescription monitoring application 214 can then prepare to transmit the encrypted formatted data from the prescription drug claims or transactions to the prescription monitoring program system 208.

Block 408 is followed by block 410, in which the data from validated claims are transmitted to a prescription monitoring program system. For example, as shown in FIG. 1, the PMP data extraction process 110 can transmit some or all of the encrypted formatted data from prescription drug claims or transactions to the prescription monitoring program system 112. In another example, as shown in FIG. 2, the processor 210 or prescription monitoring application 214 can transmit the encrypted formatted data from the prescription drug claims or transactions to the prescription monitoring program system 208 or prescription analysis application 230.

The method 400 of FIG. 4 ends after block 410.

The example elements of FIGS. 3 and 4 are shown by way of example, and other process embodiments can have fewer or greater numbers of elements, and such elements can be arranged in alternative configurations in accordance with other embodiments of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer such as a switch, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational elements or steps to be performed on the computer or other programmable apparatus to produce a computer implemented process such that the instructions that execute on the computer or other programmable apparatus provide elements for implementing the functions specified in the flowchart block or blocks.

Accordingly, blocks of the block diagrams and flowchart illustrations support combinations of means for performing the specified functions, combinations of elements or steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions, elements, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

The claimed invention is:

1. A controlled substance claims handling system for facilitating real-time processing of claims, the claims handling system comprising:
a prescription monitoring application operable to:
receive a plurality of claims associated with one or more controlled substances, wherein each of the claims relates to both at least one predefined provider and at least one monitored controlled substance;
validate at least a portion of the plurality of claims; and
transmit data associated with validated claims to a prescription monitoring program system.

2. The system of claim 1, wherein to receive a plurality of claims associated with one or more controlled substances comprises receiving a plurality of claims and associated responses from at least one of the following: a controlled substance provider, a third party benefit plan administrator, or a third party claim network or switch.

3. The system of claim 1, wherein to receive a plurality of claims associated with one or more controlled substances comprises receiving one or more claims via at least one claims transaction switch.

4. The system of claim 1, wherein controlled substances comprise at least one of following: a Schedule II list-type drug, a Schedule III list-type drug, a Schedule IV list-type drug, a Schedule V list-type drug, a federally regulated drug, or a state regulated drug.

5. The system of claim 1, wherein the at least one predefined provider comprises at least one of a plurality of participating providers of monitored controlled substances.

6. The system of claim 1, wherein the at least one monitored controlled substance comprises at least one of a plurality of selected controlled substances.

7. The system of claim 1, wherein to validate at least a portion of the claims comprises filtering claims to exclude corresponding reversal transactions made on the same date or within a predefined time period.

8. The system of claim 1, wherein to validate at least a portion of the claims comprises filtering claims to exclude multiple claims for the same prescription dispensing event made on the same date or within a predefined time period.

9. The system of claim 1, wherein to validate at least a portion of the claims comprises applying one or more rules provided by a governmental entity.

10. The system of claim 1, wherein the prescription monitoring application is further operable to:
format data from at least a portion of the validated claims in a predefined format prior to transmission.

11. The system of claim 1, wherein the prescription monitoring application is further operable to:
encrypt at least a portion of the validated claims prior to transmission.

12. The system of claim 1, wherein to transmit remaining claims to a prescription monitoring program system comprises transmitting data from the validated claims at a predefined frequency.

13. A method for facilitating real-time processing of claims associated with one or more controlled substances, the method comprising:
receiving a plurality of claims from a claims transaction switch, wherein each of the claims relates to both at least one predefined provider and at least one monitored controlled substance;
validating some or all of the plurality of claims; and
formatting and transmitting data from validated claims to a prescription monitoring program system.

14. The method of claim 13, wherein receiving a plurality of claims associated with one or more controlled substances comprises receiving a plurality of claims and associated responses from at least one of the following: a controlled substance provider, a third party benefit plan administrator, or a third party claim network or switch.

15. The method of claim 13, wherein receiving a plurality of claims associated with one or more controlled substances comprises receiving one or more claims and associated responses via at least one claims transaction switch.

16. The method of claim 13, wherein controlled substances comprise at least one of following: a Schedule II list-type drug, a Schedule III list-type drug, a Schedule IV list-type drug, a Schedule V list-type drug, a federally regulated drug, or a state regulated drug.

17. The method of claim 13, wherein the at least one predefined provider comprises at least one of a plurality of participating providers of monitored controlled substances.

18. The method of claim 13, wherein the at least one monitored controlled substance comprises at least one of a plurality of selected controlled substances.

19. The method of claim 13, wherein to validate some or all of the claims comprises filtering claims to exclude corresponding reversal transactions made on the same date or within a predefined period of time.

20. The method of claim 13, wherein to validate some or all of the claims comprises filtering claims to exclude multiple claims for the same prescription dispensing event made on the same date or within a predefined period of time.

21. The method of claim 13, wherein to validate at least a portion of the claims comprises applying one or more rules provided by a governmental entity.

22. The method of claim 13, further comprising:
formatting data from at least a portion of the validated claims in a predefined format prior to transmission.

23. The method of claim 13, further comprising:
encrypting at least a portion of the remaining claims prior to transmission.

24. The method of claim 13, wherein transmitting data from validated claims to a prescription monitoring program system comprises transmitting the validated claims at a predefined frequency.

25. A system for facilitating real-time or near real-time processing of controlled substance claims, the system comprising:
a prescription monitoring application operable to:
receive a plurality of claims associated with one or more controlled substances, wherein each of the claims relates to both at least one predefined provider and at least one monitored controlled substance;
filter at least a portion of the plurality of claims to exclude any reversal transactions and any multiple claims for similar prescription requests;
format at least a portion of data from any validated claims in a predefined format prior to transmission;
encrypt the data from any validated claims prior to transmission; and
transmit the data from any validated claims to a prescription monitoring program system.

26. A method for facilitating real-time or near real-time processing of controlled substance prescription claims, the method comprising:
receiving a plurality of claims from a claims transaction switch, wherein each of the claims relates to both at least one predefined provider and at least one monitored controlled substance;
filtering some or all of the plurality of claims to exclude any reversal transactions and any multiple claims for similar prescription requests;
formatting data from at least a portion of data from any validated claim in a predefined format prior to transmission;
encrypting at least a portion of data from any validated claims prior to transmission; and
transmitting the data from any validated claims to a prescription monitoring program system.
